(19) United States
(12) Patent Application Publication
(10) Pub. No.: US 2026/0012279 A1
(43) Pub. Date: Jan. 8, 2026

(54) TERMINAL AND OPTICAL NETWORK

(71) Applicant: Fujikura Ltd., Tokyo (JP)

(72) Inventor: Naoyuki Sugiyama, Sakura-shi (JP)

(73) Assignee: Fujikura Ltd., Tokyo (JP)

(21) Appl. No.: 18/873,417

(22) PCT Filed: Feb. 13, 2023
(86) PCT No.: PCT/JP2023/004683

§ 371 Date: Dec. 10, 2024

(30) Foreign Application Priority Data
Jun. 14, 2022 (JP) 2022-095815

(51) Int. Cl. H04J 14/02; H04B 10/25

(52) U.S. Cl. CPC H04J 14/02; H04B 10/25

(57) ABSTRACT

A terminal that inputs and outputs optical signals of optical fibers in an optical cable includes a housing, an input port that introduces the optical signals into an inside of the housing, wavelength demultiplexers that receive and demultiplex the introduced optical signals into a wavelength band and wavelength bands other than the wavelength band, a distribution port that distributes optical signals demultiplexed into the wavelength band to an external terminal, and an output port that extracts optical signals demultiplexed into the wavelength bands to an outside of the housing. A total number of the wavelength demultiplexers is equal to a total number of the optical fibers. Each of the wavelength demultiplexers is connected to a corresponding optical fiber of the optical fibers.

### CROSS-REFERENCE TO RELATED APPLICATIONS

The present application is a national phase application of International Application No. PCT/JP2023/004683, filed Feb. 13, 2023, which claims priority to Japanese Patent Application No. 2022-095815, filed Jun. 14, 2022. The contents of these applications are incorporated herein by reference in their entirety.

### BACKGROUND

### Technical Field

The present invention relates to a terminal and an optical network.

### Discussion of the Background

In order to construct a wide area communication network, various methods of laying an optical network have been proposed. For example, Patent Document 1 discloses an optical network including a plurality of terminals (terminal 110) and a plurality of connection cables (distribution cables 150A to 150H) for relaying between the terminals (see FIG. 1 of Patent Document 1). Each terminal includes a first port (first port 112) connected to a subscriber terminal (subscribers 109) and a second port (second port 114) connected to a next terminal. Each cable includes twelve connection optical fibers (see FIG. 2 of Patent Document 1). The twelve optical fibers are allocated to twelve positions P1 to P12, one by one, by a connector (connector 156).

In each terminal, the optical fiber (first optical fiber 152) allocated to the position P1 is connected to the first port. As a result, an optical signal transmitted by the optical fiber allocated to the position P1 is transmitted to the subscriber terminal. Meanwhile, the optical fibers (remaining optical fiber 154) allocated to the positions P2 to P12 are connected to the second port. As a result, each optical signal transmitted by the optical fibers allocated to the positions P2 to P12 is forwarded to the next terminal. In this case, the optical fibers that were allocated to the positions P2 to P12 are reallocated to positions P1′ to P11′ respectively, and then connected to the next terminal. As a result, in the next terminal, the optical fiber allocated to the position P1′ is connected to the first port, and the optical fibers allocated to the positions P2′ to P11′ are connected to the second port. With such a configuration, a daisy-chain optical network can be realized.

### Patent Document

Patent Document 1: U.S. Pat. No. 9,348,096

Meanwhile, in the optical network disclosed in Patent Document 1, the actual number of optical fibers in an optical cable connecting the terminals is reduced toward a downstream side. In other words, an effective density of the optical fibers with respect to the optical cable decreases.

### SUMMARY

One or more embodiments provide a terminal and an optical network capable of maintaining an effective density of optical fibers.

A terminal of a first aspect of one or more embodiments is a terminal that inputs and outputs optical signals of a plurality of optical fibers included in an optical cable, the terminal including: a housing; an input port configured to introduce the optical signals into an inside of the housing; a plurality of wavelength demultiplexers to which the optical signals introduced from the input port are input and configured to demultiplex the optical signals into a predetermined wavelength band and other wavelength bands; a distribution port configured to distribute the optical signals in the predetermined wavelength band demultiplexed by the wavelength demultiplexer to an external terminal; and an output port configured to extract the optical signals in the wavelength bands other than the predetermined wavelength band, which are demultiplexed by the wavelength demultiplexer to an outside of the housing. The number of the plurality of wavelength demultiplexers is equal to the number of the plurality of optical fibers, and each of the plurality of wavelength demultiplexers and each of the plurality of optical fibers are connected.

In addition, in a terminal of a second aspect of one or more embodiments, in the terminal of the first aspect, in a case in which an optical fiber that transmits the optical signals from the input port to the wavelength demultiplexer is defined as an input fiber and an optical fiber that transmits the optical signals from the wavelength demultiplexer to the output port is defined as an output optical fiber, the input optical fiber and the output optical fiber may be connected on a one-to-one basis via the wavelength demultiplexer, and a position in the input port and a position in the output port may be different from each other in the connected input optical fiber and output optical fiber.

In addition, a terminal of a third aspect of one or more embodiments may be a terminal in which, in the terminal of the first aspect or the second aspect, only one wavelength band is set in the wavelength demultiplexer.

In addition, in a terminal of a fourth aspect of one or more embodiments, in the terminal of the first aspect or the second aspect, a plurality of the wavelength bands may be set in the wavelength demultiplexer.

In addition, in a terminal of a fifth aspect of one or more embodiments, in the terminal of any one of the first aspect to the fourth aspect, the plurality of wavelength demultiplexers may be provided, and the wavelength bands to be set may be the same as each other for the plurality of wavelength demultiplexers.

In addition, in a terminal of a sixth aspect of one or more embodiments, in the terminal of any one of the first aspect to the fourth aspect, the plurality of wavelength demultiplexers may be provided, and the wavelength bands to be set may be different from each other for the plurality of wavelength demultiplexers.

In addition, an optical network of a seventh aspect of one or more embodiments includes a plurality of the terminals of any one of the first aspect to the sixth aspect.

In addition, an optical network of an eighth aspect of one or more embodiments is an optical network including: a plurality of the terminals of the sixth aspect, in which the terminal includes a first terminal and a second terminal, the plurality of wavelength demultiplexers included in the first terminal and the plurality of wavelength demultiplexers included in the second terminal are connected on a one-to-one basis, and the wavelength bands to be set are different from each other in the wavelength demultiplexer of the first terminal and the wavelength demultiplexer of the second terminal connected to each other.

According to one or more embodiments, it is possible to provide a terminal and an optical network capable of maintaining an effective density of optical fibers.

### BRIEF DESCRIPTION OF THE DRAWINGS

FIG. 1 is a diagram showing an optical network according to a first example.

FIG. 2 is a diagram showing a terminal according to the first example.

FIG. 3A is a diagram showing one end of a connection optical cable according to the first example.

FIG. 3B is a diagram showing an input port according to the first example.

FIG. 4A is a diagram showing one end of a supply optical cable according to the first example.

FIG. 4B is a diagram showing a distribution port according to the first example.

FIG. 5 is a wiring diagram showing the optical network according to a first example.

FIG. 6 is a wiring diagram showing an optical network according to a second example.

### DESCRIPTION OF THE EMBODIMENTS

### First Example

Hereinafter, a terminal 1 and an optical network NW1 using the terminal 1 according to a first example are described with reference to the accompanying drawings.

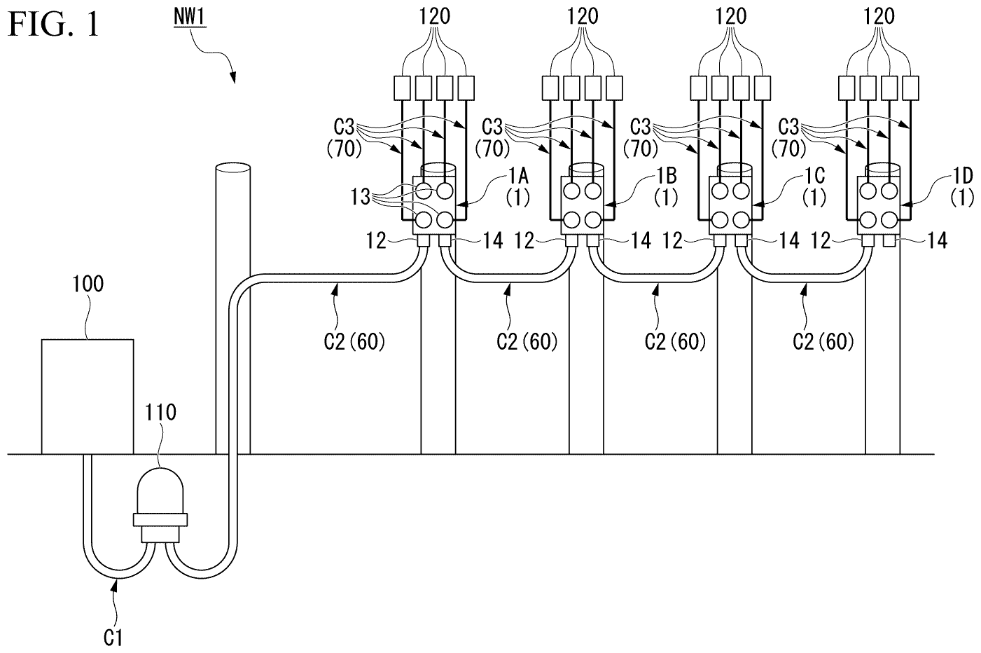

As shown in FIG. 1, the optical network NW1 according to the present example includes a first terminal 1A, a second terminal 1B, a third terminal 1C, and a fourth terminal 1D. In the present example, the terminals 1A to 1D are connected in a daisy chain manner by connection optical cables C2. That is, the pair of the terminal 1A and terminal 1B, the pair of terminal 1B and terminal 1C, and the pair of terminal 1C and terminal 1D are each connected by the connection optical cable C2. Each of the terminals 1A to 1D is fixed to, for example, a utility pole or the like. Hereinafter, when the terminals 1A to 1D are not particularly distinguished, the terminals 1A to 1D may be simply referred to as the “terminal 1.” The terminals 1A to 1D are also referred to as “network terminals.”

The terminal 1A according to the present example is connected to a station 100 via a closure 110 buried in the ground. More specifically, the terminal 1A and the closure 110 are connected by the connection optical cable C2, and the closure 110 and the station 100 are connected by a wiring optical cable C1. In addition, each of the terminals 1A to 1D is connected to a plurality of subscriber terminals 120 by the optical fibers included in supply optical cables C3. Each of the terminals 1A to 1D has a role of distributing the optical signal transmitted from the station 100 to each subscriber terminal 120. Hereinafter, an orientation from the terminal 1A to the terminal 1D may be referred to as the “downstream side,” and an orientation from the terminal 1D to the terminal 1A may be referred to as the “upstream side.”

Next, the mechanical configuration of each of the terminals 1A to 1D is described. The mechanical configurations of the terminals 1A to 1D are basically the same.

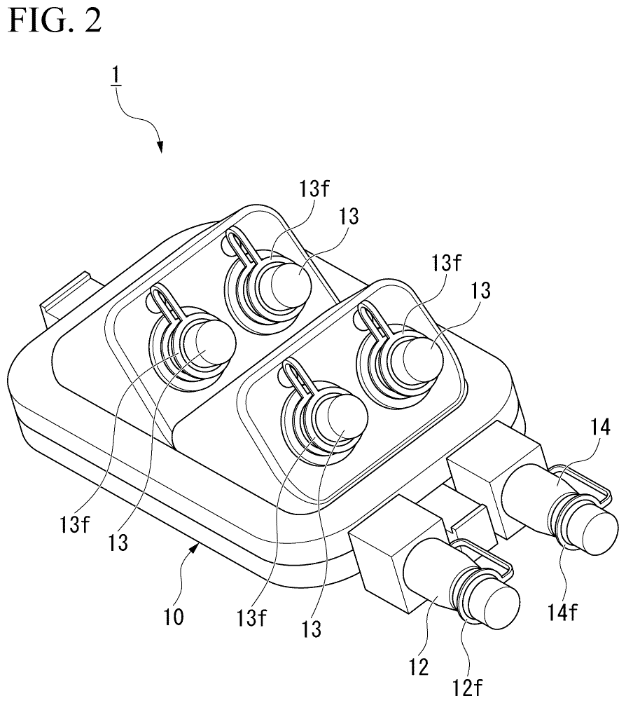

As shown in FIG. 2, the terminal 1 according to the present example includes a housing 10. The housing 10 includes an input port 12, an output port 14, and four distribution ports 13. As shown in FIG. 1, one end of the connection optical cable C2 is connected to the input port 12. One end of the connection optical cable C2 different from the connection optical cable C2 connected to the input port 12 is connected to the output port 14. One end of the supply optical cable C3 is connected to each distribution port 13.

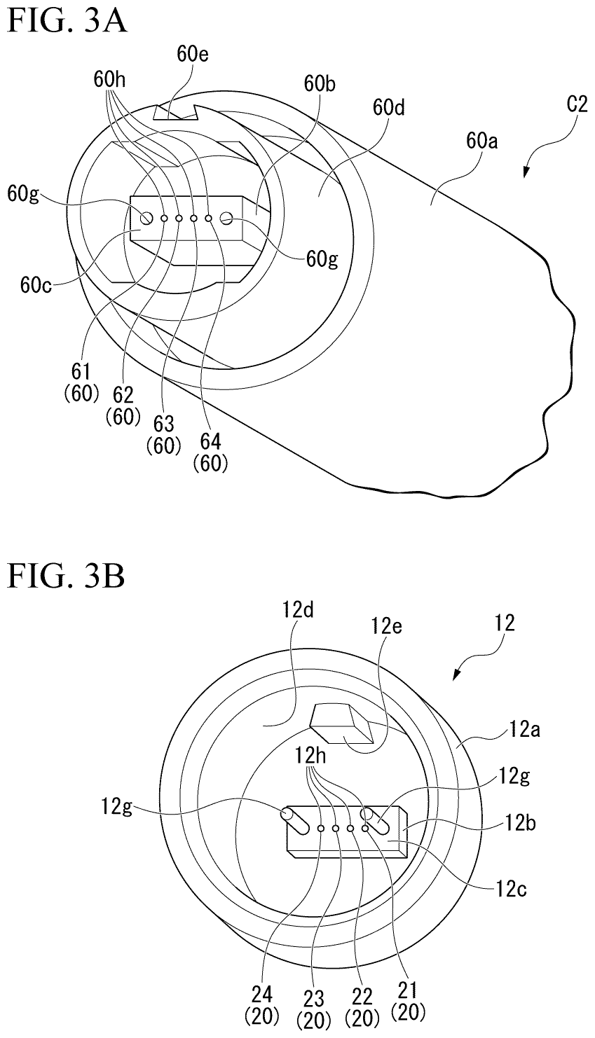

As shown in FIG. 3A, each connection optical cable C2 includes four connection optical fibers 60. “Connection optical fiber 60” is a general term for an optical fiber that connects the terminals 1 to each other or an optical fiber that connects the closure 110 and the terminal 1. It can also be said that the connection optical fiber 60 is an optical fiber included in the connection optical cable C2. The connection optical fiber 60 is disposed outside the housing 10. In the present example, the end portion of the connection optical cable C2 is equipped with a connector. In other words, a (multi-fiber) connector 60a is provided at the end portion of the connection optical cable C2. The connector 60a includes a ferrule 60b having a connection end surface 60c, and a tubular plug portion 60d. Four fiber holes 60h and a pair of guide holes 60g are open on the connection end surface 60c. Each connection optical fiber 60 is inserted through the fiber hole 60h such that the distal end thereof is positioned on the connection end surface 60c, and is held by the ferrule 60b. The ferrule 60b is positioned radially inside the plug portion 60d. A key groove 60e that is recessed radially inward from the outer peripheral surface of the plug portion 60d is formed in the plug portion 60d. In the present example, in order to facilitate the understanding of the description, the description is given assuming that the number of connection optical fibers 60 included in one connector 60a is four, but the number of connection optical fibers 60 may be four or more, for example, twelve, twenty-four, or the like. The ferrule 60b in which the number of fiber holes 60h is the same as the number of connection optical fibers 60 is applied in accordance with the number of connection optical fibers 60.

As shown in FIG. 3B, the input port 12 includes four input optical fibers 20. “Input optical fiber 20” is a general term for an optical fiber that transmits the optical signal input to the terminal 1 to a wavelength demultiplexer 50 (described later). The input optical fiber 20 is disposed inside the housing 10. The input port 12 is provided with a receptacle 12a into which the connector 60a is inserted. The receptacle 12a includes an insertion hole 12d into which the plug portion 60d is inserted, and a ferrule 12b disposed inside the insertion hole 12d.

The ferrule 12b includes a connection end surface 12c with four fiber holes 12h opened. In addition, the ferrule 12b includes a pair of guide pins 12g that extend from the connection end surface 12c. Each input optical fiber 20 is inserted through the fiber hole 12h such that the distal end thereof is positioned on the connection end surface 12c, and is held by the ferrule 12b. In addition, a key 12e is formed inside the insertion hole 12d. The shapes of the insertion hole 12d, key 12e, and guide pin 12g respectively correspond to the shapes of the plug portion 60d, key groove 60e, and guide hole 60g.

As shown in FIG. 2, a cap 12f that can close the receptacle 12a is attached to the input port 12 according to the present example. The user removes the cap 12f and inserts the connector 60a into the receptacle 12a such that the key 12e and the key groove 60e are fitted, and the guide pin 12g is inserted into the guide hole 60g (see also FIGS. 3A and 3B). As a result, the connection optical cable C2 and the input port 12 can be connected. More specifically, the connection optical fibers 60 and the input optical fibers 20 can be connected on a one-to-one basis by bringing the connection end surface 60c of the ferrule 60b and the connection end surface 12c of the ferrule 12b into contact with each other.

As shown in FIG. 3A, in the present example, each of the four connection optical fibers 60 is referred to as a first connection optical fiber 61, a second connection optical fiber 62, a third connection optical fiber 63, and a fourth connection optical fiber 64. That is, the four connection optical fibers 60 are respectively assigned numbers (ordinal numbers) from 1 to 4 (first to fourth). In the present example, the ordinal numbers of the connection optical fibers 60 respectively correspond to the positions of the connection optical fibers 60 in the ferrule 60b. More specifically, the ordinal numbers of the connection optical fibers 60 respectively correspond to which of the fiber holes 60h the connection optical fibers 60 are inserted through. For example, in the example of FIG. 3A, the ordinal number of the first connection optical fiber 60 from the left is “1”, and the ordinal number of the second connection optical fiber 60 from the left is “2.” The correspondence relationship (order) between the fiber holes 60h and the ordinal numbers is not limited to the shown example. The correspondence relationship between the positions of the fiber holes 60h and the ordinal numbers may be common for all the connection optical cables C2 included in the optical network NW1. Alternatively, the correspondence relationship between the positions of the fiber holes 60h and the ordinal numbers may be common only in some of the connection optical cables C2.

As shown in FIG. 3B, the input optical fibers 20 are also assigned the ordinal numbers from 1 to 4 in the same manner as the connection optical fibers 60. Specifically, the input optical fiber 20 connected to the first connection optical fiber 61 is referred to as a first input optical fiber 21. Similarly, the input optical fibers 20 connected to the second connection optical fiber 62 to the fourth connection optical fiber 64 are respectively referred to as a second input optical fiber 22 to a fourth input optical fiber 24. As described above, the connection optical fiber 60 and the input optical fiber 20 are connected by bringing the connection end surface 60c of the ferrule 60b and the connection end surface 12c of the ferrule 12b into contact with each other. Therefore, the ordinal numbers of the input optical fibers 20 respectively correspond to the positions of the input optical fibers 20 in the input port 12 (ferrule 12b), that is, the positions where the input optical fibers 20 are inserted through a plurality of the fiber holes 12h. For example, in the example of FIG. 3B, the ordinal number of the first input optical fiber 20 from the right is “1”, and the ordinal number of the second input optical fiber 20 from the right is “2.”

Although not shown in drawings, the output port 14 has a configuration similar to that of the input port 12. That is, the output port 14 includes four output optical fibers 40, and the output port 14 is provided with a receptacle 14a into which the connector 60a is inserted. “Output optical fiber 40” is a general term for an optical fiber that transmits the optical signal demultiplexed by the wavelength demultiplexer 50 (described later) to the connection optical fiber 60. The output optical fiber 40 is disposed inside the housing 10. The user can connect the connection optical cable C2 and the output port 14 by removing a cap 14f and inserting the connector 60a into the receptacle 14a, thereby connecting the plurality of connection optical fibers 60 and a plurality of the output optical fibers 40 on a one-to-one basis. The output optical fibers 40 are also assigned the ordinal numbers from 1 to 4 in the same manner as the input optical fiber 20. Specifically, the output optical fibers 40 connected to the first connection optical fiber 61 to the fourth connection optical fiber 64 are respectively referred to as a first output optical fiber 41 to a fourth output optical fiber 44. Similarly to the ordinal numbers of the input optical fibers 20, the ordinal numbers of the output optical fibers 40 respectively correspond to the positions of the output optical fibers 40 in the output port 14.

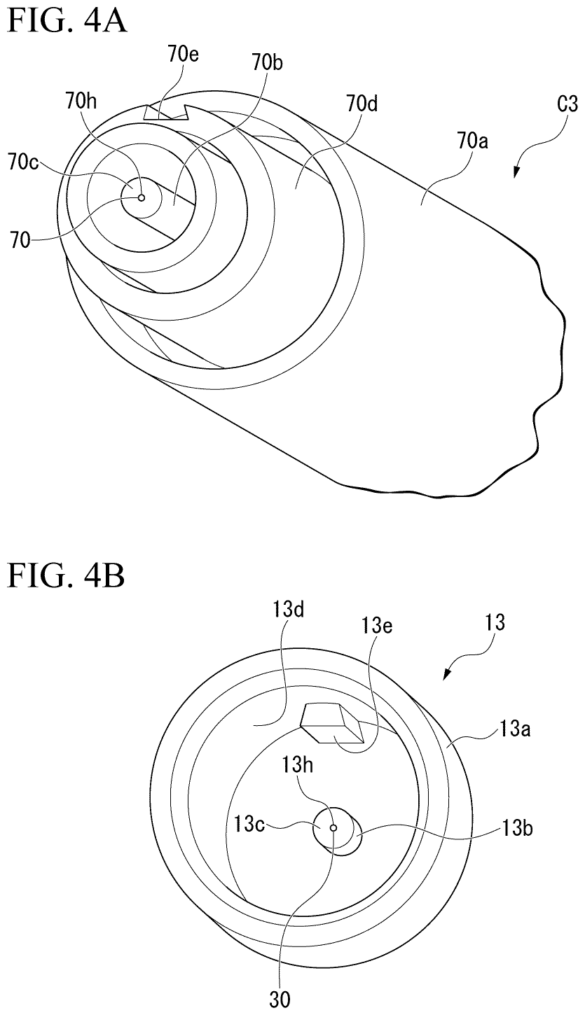

As shown in FIG. 4A, each supply optical cable C3 includes one supply optical fiber 70. “Supply optical fiber 70” is a general term for an optical fiber that transmits the optical signal delivered from a distribution optical fiber 30 (described later) to the subscriber terminal 120. The supply optical fiber 70 is disposed outside the housing 10. In the present example, one end of the supply optical cable C3 is equipped with a connector. In other words, a (single-fiber) connector 70a is provided at one end of the supply optical cable C3. The connector 70a includes a ferrule 70b having a connection end surface 70c, and a tubular plug portion 70d. One fiber hole 70h is open on the connection end surface 70c. The supply optical fiber 70 is inserted through the fiber hole 70h such that the distal end thereof is positioned on the connection end surface 70c, and is held by the ferrule 70b. The ferrule 70b is positioned radially inside the plug portion 70d. A key groove 70e that is recessed radially inward from the outer peripheral surface of the plug portion 70d is formed in the plug portion 70d.

As shown in FIG. 4B, each distribution port 13 includes one distribution optical fiber 30. “Distribution optical fiber 30” is a general term for an optical fiber that transmits the optical signal extracted by the wavelength demultiplexer 50 (described later) to the supply optical fiber 70. The distribution optical fiber 30 is disposed inside the housing 10. The distribution port 13 is provided with a receptacle 13a into which the connector 70a is inserted. The receptacle 13a includes an insertion hole 13d into which the plug portion 70d is inserted, and a ferrule 13b disposed inside the insertion hole 13d. The ferrule 13b includes a connection end surface 13c with one fiber hole 13h opened. The distribution optical fiber 30 is inserted through the fiber hole 13h such that the distal end thereof is positioned on the connection end surface 13c, and is held by the ferrule 13b. In addition, a key 13e is formed inside the insertion hole 13d. The shapes of the insertion hole 13d and key 13e respectively correspond to the shapes of the plug portion 70d and key groove 70e.

The user can connect the supply optical cable C3 and the distribution port 13 by removing the cap 13f shown in FIG. 2 and inserting the connector 70a into the receptacle 13a such that the key 13e and the key groove 70e are fitted. More specifically, the supply optical fiber 70 and the connection optical fiber 60 can be connected by bringing the connection end surface 70c of the ferrule 70b and the connection end surface 13c of the ferrule 13b into contact with each other.

Next, the internal wiring of the terminals 1A to 1D and the connection between the terminals 1A to 1D using the connection optical cable C2 are described.

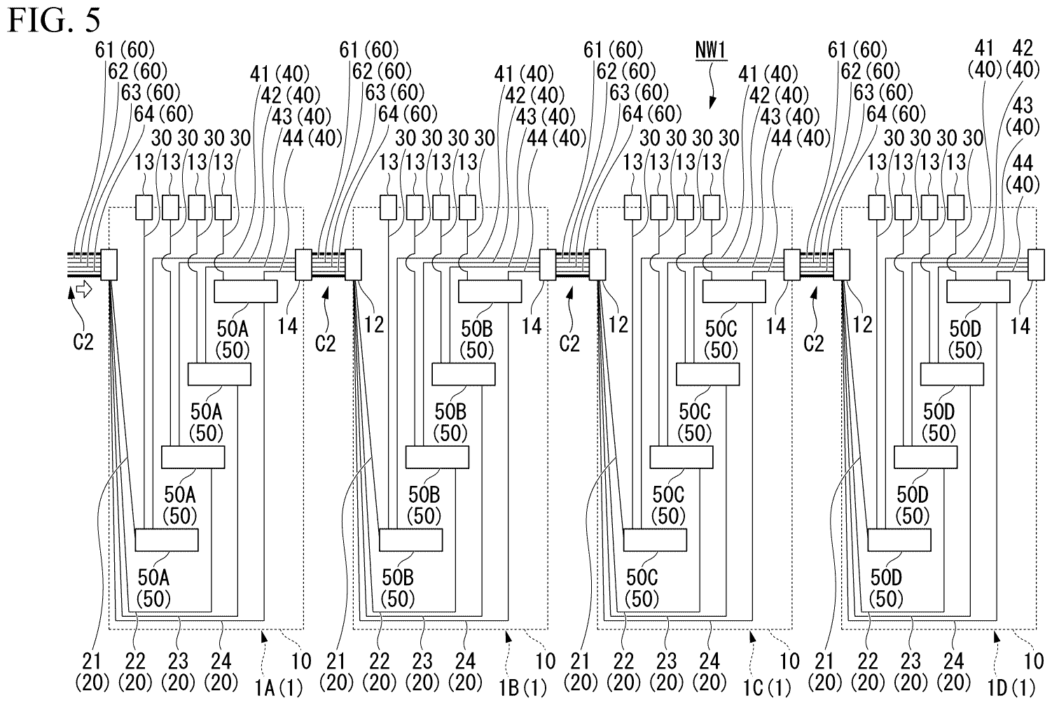

As shown in FIG. 5, the terminal 1A includes four wavelength demultiplexers 50A. Similarly, the terminal 1B includes four wavelength demultiplexers 50B, the terminal 1C includes four wavelength demultiplexers 50C, and the terminal 1D includes four wavelength demultiplexers 50D. Although the details are not shown in the drawings, the wavelength demultiplexers 50A to 50D are respectively accommodated in the housings 10 included in the terminals 1A to 1D. Hereinafter, when the wavelength demultiplexers 50A to 50D are not particularly distinguished, the wavelength demultiplexers 50A to 50D may be simply referred to as the “wavelength demultiplexer 50.”

In each terminal 1, the input optical fibers 21 to 24 connect the connection optical fibers 61 to 64 and the four wavelength demultiplexers 50 on a one-to-one basis. That is, the number of the wavelength demultiplexers 50 is equal to the number of the connection optical fibers 61 to 64 that input the optical signal to the terminal 1, and the wavelength demultiplexers 50 and the connection optical fibers 61 to 64 correspond on a one-to-one basis. In addition, the output optical fibers 41 to 44 connect the connection optical fibers 61 to 64 and the four wavelength demultiplexers 50 on a one-to-one basis. As a result, for example, the output optical fibers 41 to 44 included in terminal 1A and the input optical fibers 21 to 24 included in terminal 1B are respectively connected via the connection optical fibers 61 to 64. The same applies to the terminals 1B to 1D.

In addition, in the example shown in FIG. 5, the number of wavelength demultiplexers 50 is the same as the number of distribution ports 13, and the wavelength demultiplexers 50 and the distribution ports 13 are connected on a one-to-one basis by the distribution optical fibers 30. That is, in the example shown in FIG. 5, one input optical fiber 20, one distribution optical fiber 30, and one output optical fiber 40 are connected to one wavelength demultiplexer 50.

The wavelength demultiplexer 50 demultiplexes the optical signal input from the input optical fiber 20 into the distribution optical fiber 30 and the output optical fiber 40 depending on the wavelength of the optical signal. More specifically, in wavelength demultiplexers 50 according to the present example, specific wavelength bands B are respectively set. The wavelength demultiplexer 50 extracts the optical signal belonging to the wavelength band B from the input optical signal and outputs the extracted optical signal to the distribution optical fiber 30. In addition, the wavelength demultiplexer 50 outputs all the optical signals that do not belong to the wavelength band B among the input optical signals to the output optical fiber 40. That is, the wavelength demultiplexer 50 outputs all the optical signals that are not output to the distribution optical fiber 30 among the input optical signals to the output optical fiber 40. The wavelength demultiplexer 50 is also referred to as a wavelength division multiplexing (WDM) module. The optical signal output to the distribution optical fiber 30 is transmitted to the subscriber terminal 120 via the supply optical cable C3 (supply optical fiber 70) (see also FIG. 1).

As shown in FIG. 5, the optical signals output to the output optical fibers 41 to 44 are drawn out to the outside of the housing 10 and are input to the input optical fibers 21 to 24 included in the next terminal 1 via the connection optical fibers 61 to 64. For example, the optical signals output from the output optical fibers 41 to 44 of terminal 1A are input to the input optical fibers 21 to 24 of terminal 1B.

In the present example, the input optical fiber 20 and the output optical fiber 40 which are connected to the same wavelength demultiplexer 50 are assigned the same number (ordinal number). In other words, the input optical fiber 20 and the output optical fiber 40, which are assigned the same number (ordinal number), are connected on a one-to-one basis via the wavelength demultiplexer 50. For example, the first input optical fiber 21 and the first output optical fiber 41 are connected to the same wavelength demultiplexer 50.

The set value of the above-described wavelength band B can be changed as appropriate by the user according to the design of the optical network NW1. In the present example, the wavelength bands B to be set for the four wavelength demultiplexers 50A are the same as each other. Similarly, the wavelength bands B to be set for the four wavelength demultiplexers 50B are the same as each other. The wavelength bands B to be set for the four wavelength demultiplexers 50C are the same as each other. The wavelength bands B to be set for the four wavelength demultiplexers 50D are the same as each other. Hereinafter, the wavelength band to be set in the wavelength demultiplexer 50A is referred to as a first wavelength band B1, the wavelength band to be set in the wavelength demultiplexer 50B is referred to as a second wavelength band B2, the wavelength band to be set in the wavelength demultiplexer 50C is referred to as a third wavelength band B3, and the wavelength band to be set in the wavelength demultiplexer 50D is referred to as a fourth wavelength band B4. In the present example, the wavelength bands B1 to B4 are different from each other. That is, the wavelengths of the optical signals extracted by the wavelength demultiplexers 50A to 50D and output to the distribution optical fibers 30 are different for the terminals 1A to 1D.

Next, an operation of the optical network NW1 configured as described above is described.

When the optical signal is distributed to each subscriber terminal 120 using the above-described optical network NW1, an optical signal S is sent from the station 100 to each of the connection optical fibers 61 to 64 via the wiring optical cable C1 and the closure 110 (hereinafter, see FIGS. 1 and 5). In the present example, the optical signal S includes an optical signal S1 belonging to the first wavelength band B1, an optical signal S2 belonging to the second wavelength band B2, an optical signal S3 belonging to the third wavelength band B3, and an optical signal S4 belonging to the fourth wavelength band B4.

For example, the optical signal S sent from the station 100 to the first connection optical fiber 61 is first input to the wavelength demultiplexer 50A included in the terminal 1A. The wavelength demultiplexer 50A extracts the optical signal S1 from the optical signal S and outputs the optical signal S1 to the distribution optical fiber 30. As a result, the optical signal S1 is transmitted to the subscriber terminal 120 connected to the distribution port 13 of terminal 1A. In addition, the wavelength demultiplexer 50A outputs the remaining optical signal S (that is, the optical signals S2 to S4) to the first output optical fiber 41.

The optical signal S, including the optical signals S2 to S4, is input to the wavelength demultiplexer 50B included in the terminal 1B. The wavelength demultiplexer 50B extracts the optical signal S2 from the optical signal S and outputs the optical signal S2 to the distribution optical fiber 30. As a result, the optical signal S2 is transmitted to the subscriber terminal 120 connected to the distribution port 13 of terminal 1B. In addition, the wavelength demultiplexer 50B outputs the remaining optical signal S (that is, the optical signals S3 and S4) to the first output optical fiber 41.

The optical signal S, including the optical signals S3 and S4, is input to the wavelength demultiplexer 50C included in the terminal 1C. The wavelength demultiplexer 50C extracts the optical signal S3 from the optical signal S and outputs the optical signal S3 to the distribution optical fiber 30. The wavelength demultiplexer 50C outputs the remaining optical signal S (that is, the optical signal S4) to the first output optical fiber 41. The optical signal S, including the optical signal S4, is input to the wavelength demultiplexer 50D included in the terminal 1D. The wavelength demultiplexer 50D extracts the optical signal S4 from the optical signal S and outputs the optical signal S4 to the distribution optical fiber 30. As described above, in the optical network NW1 according to the present example, the optical signal S sent from the station 100 to the first connection optical fiber 61 is input once to all the wavelength demultiplexers 50A to 50D.

Although the optical signal S sent from the station 100 to the first connection optical fiber 61 is described above, the optical signals S respectively sent from the station 100 to the second connection optical fiber 62 to the fourth connection optical fiber 64 are also input once to all the wavelength demultiplexers 50A to 50D by the same principle as described above. With this configuration, the optical signals S1 to S4 can be extracted from the respective optical signals S sent from the station 100 to the connection optical fibers 61 to 64, and the optical signals can be distributed to the respective subscriber terminals 120.

As described above, the terminal 1 according to the present example is a terminal that inputs and outputs optical signals of a plurality of optical fibers 60 included in an optical cable C2, the terminal 1 including: the housing 10; the input port 12 configured to introduce the optical signals into an inside of the housing 10; the plurality of wavelength demultiplexers 50 to which the optical signals introduced from the input port 12 are input and configured to demultiplex the optical signals into a predetermined wavelength band and other wavelength bands; the distribution port 13 configured to distribute the optical signals in the predetermined wavelength band demultiplexed by the wavelength demultiplexer 50 to an external terminal (subscriber terminal 120); and the output port 14 configured to extract the optical signals in the wavelength bands other than the predetermined wavelength band, which are demultiplexed by the wavelength demultiplexer 50 to an outside of the housing 10. The number of the wavelength demultiplexers 50 included in each terminal 1 is equal to the number of the optical fibers 60 that input the optical signals to the terminal 1, and the plurality of wavelength demultiplexers 50 and the plurality of optical fibers 60 are respectively connected.

A plurality of the terminals 1 having this configuration are prepared, and the plurality of terminals 1 are connected by the connection optical fibers 61 to 64, whereby the daisy-chain optical network NW1 in which the optical signal can be distributed from the station 100 to the subscriber terminal 120 can be realized. In addition, in the realized optical network NW1, for example, unlike the optical network disclosed in Patent Document 1, the number of optical fibers 60 (connection optical fibers 61 to 64) that input the optical signal to the terminal 1 and the number of connection optical fibers 61 to 64 to which the optical signal is output from the terminal 1 are equal to each other. Therefore, for example, the effective density of the connection optical fibers 61 to 64 can be maintained over the entire optical network NW1 as compared with the optical network disclosed in Patent Document 1.

In addition, in the terminal 1 according to the present example, the plurality of wavelength demultiplexers 50 are provided, and the wavelength bands B to be set for the plurality of wavelength demultiplexers 50 are the same as each other. With this configuration, it is possible to easily realize the optical network NW1, in which the optical signal can be distributed to the subscriber terminals 120.

### Second Example

Next, a second example is described, but basic configurations thereof are the same as the configurations of the first example. Therefore, the same configurations are denoted by the same reference numerals, descriptions thereof are omitted, and only different points are described.

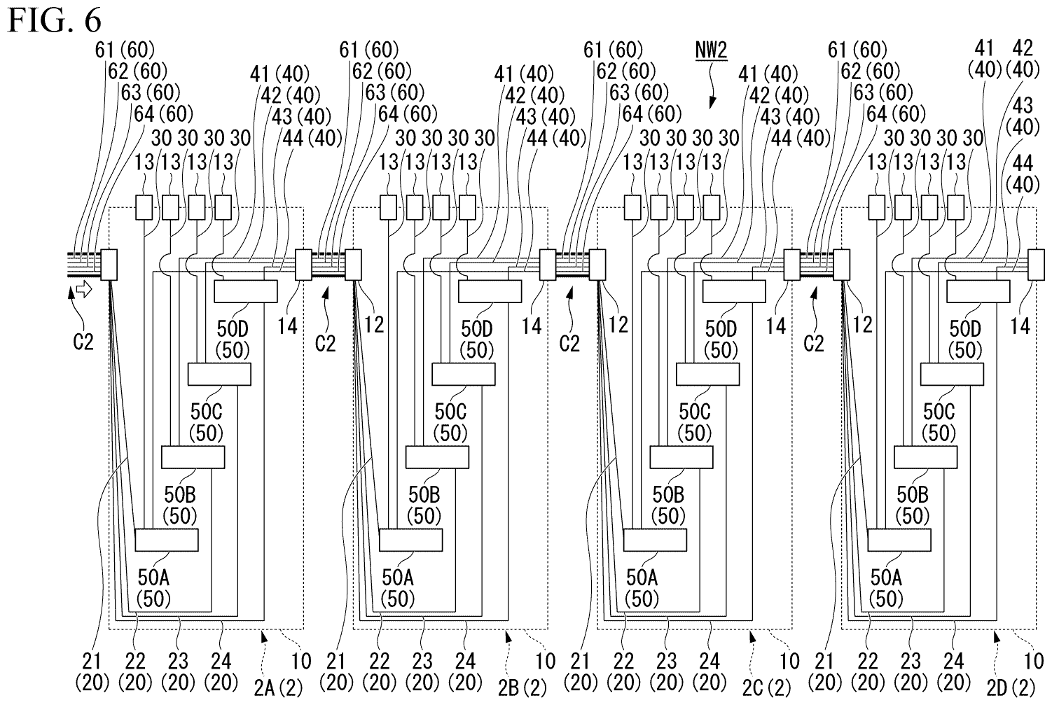

As shown in FIG. 6, in an optical network NW2 according to the present example, each of a first terminal 2A, a terminal 2B, a terminal 2C, and a terminal 2D includes the wavelength demultiplexers 50A to 50D. As a result, the configurations of the four terminals 2A to 2D are common to each other. Hereinafter, when the terminals 2A to 2D are not particularly distinguished, the terminals 2A to 2D may be simply referred to as a “terminal 2.”

In the present example, the first input optical fiber 21 and the fourth output optical fiber 44 are connected via the wavelength demultiplexer 50A. In addition, the second input optical fiber 22 and the first output optical fiber 41 are connected via the wavelength demultiplexer 50B. The third input optical fiber 23 and the second output optical fiber 42 are connected via the wavelength demultiplexer 50C. The fourth input optical fiber 24 and the third output optical fiber 43 are connected via the wavelength demultiplexer 50D. That is, for the input optical fiber 20 and the output optical fiber 40 connected via the wavelength demultiplexer 50, the numbers (ordinal numbers) assigned to the optical fibers 20 and 40 are different from each other. In other words, the position in the input port 12 (the fiber hole 12h with the input optical fiber 20 inserted) and the position in the output port 14 (a fiber hole 14h with the output optical fiber 40 inserted) are different in the connected input optical fiber 20 and output optical fiber 40.

Even with such an optical network NW2, the optical signal can be distributed from the station 100 to each subscriber terminal 120. For example, the optical signal S sent from the station 100 to the first connection optical fiber 61 is first input to the wavelength demultiplexer 50A included in the terminal 2A. The wavelength demultiplexer 50A extracts the optical signal S1 from the optical signal S and outputs the optical signal S1 to the distribution optical fiber 30. In addition, the wavelength demultiplexer 50A outputs the remaining optical signal S (that is, the optical signals S2 to S4) to the fourth output optical fiber 44.

The optical signal S, including the optical signals S2 to S4, is input to the wavelength demultiplexer 50D included in the terminal 2B. The wavelength demultiplexer 50D extracts the optical signal S4 from the optical signal S and outputs the optical signal S4 to the distribution optical fiber 30. In addition, the wavelength demultiplexer 50D outputs the remaining optical signal S (that is, the optical signals S2 and S3) to the third output optical fiber 43.

The optical signal S, including the optical signals S2 and S3, is input to the wavelength demultiplexer 50C included in the terminal 2C. The wavelength demultiplexer 50C extracts the optical signal S3 from the optical signal S and outputs the optical signal S3 to the distribution optical fiber 30. The wavelength demultiplexer 50C outputs the remaining optical signal S (that is, the optical signal S2) to the second output optical fiber 42. The optical signal S, including the optical signal S2, is input to the wavelength demultiplexer 50B included in the terminal 2D. The wavelength demultiplexer 50B extracts the optical signal S2 from the optical signal S and outputs the optical signal S2 to the distribution optical fiber 30. As described above, also in the optical network NW2 according to the present example, the optical signal S sent from the first connection optical fiber 61 is input once to all the wavelength demultiplexers 50A to 50D.

Although the optical signal S sent from the station 100 to the first connection optical fiber 61 is described above, optical signals S respectively sent from the station 100 to the second connection optical fiber 62 to the fourth connection optical fiber 64 are also configured to be input once to all the wavelength demultiplexers 50A to 50D. More specifically, as shown in FIG. 6, in two terminals 2 (for example, terminals 2A and 2B) connected to each other, the plurality of wavelength demultiplexers 50 included in one terminal 2 and the plurality of wavelength demultiplexers 50 included in the other terminal 2 are connected on a one-to-one basis. In addition, the wavelength bands B to be set for the two connected wavelength demultiplexers 50 are different from each other. With this configuration, the optical signals S1 to S4 can be extracted from the respective optical signals S sent from the station 100 to the connection optical fibers 61 to 64, and the optical signals can be distributed to the respective subscriber terminals 120.

As described above, in the terminal 2 according to the present example, the plurality of wavelength demultiplexers 50A to 50D are provided, and the wavelength bands B1 to B4 to be set for the plurality of wavelength demultiplexers 50A to 50D are different from each other. By configuring the optical network NW2 using a plurality of the terminals 2 having this configuration, the configuration of each terminal 2 can be made common throughout the entire optical network NW2. As a result, it is possible to reduce the cost when manufacturing the terminal 2.

In addition, in a case in which an optical fiber that transmits the optical signal from the input port 12 to the wavelength demultiplexer 50 is defined as an input optical fiber 20 and an optical fiber that transmits the optical signal from the wavelength demultiplexer 50 to the output port 14 is defined as an output optical fiber 40, a plurality of the input optical fibers 20 and a plurality of the output optical fibers 40 are connected on a one-to-one basis via the wavelength demultiplexer 50, and a position (number, ordinal number) in the input port 12 and a position (number, ordinal number) in the output port 14 are different from each other in the connected input optical fiber 20 and output optical fiber 40. The plurality of terminals 2 having this configuration are prepared, and the terminals 2 are connected by the connection optical cable C2 in which the connector 60a is provided at the end portion thereof, whereby the optical network NW2 in which the optical signal can be distributed to the subscriber terminal 120 can be easily realized.

In addition, the optical network NW2 according to the present example is an optical network NW2 including: a plurality of the terminals 2, in which the plurality of terminals 2 include the first terminal 2A and the second terminal 2B, the plurality of wavelength demultiplexers 50 included in the first terminal 2A and the plurality of wavelength demultiplexers 50 included in the second terminal 2B are connected on a one-to-one basis, and the wavelength bands B to be set are different from each other in the wavelength demultiplexer 50 of the first terminal 2A and the wavelength demultiplexer 50 of the second terminal 2B connected to each other. With this configuration, it is possible to more reliably realize the optical network NW2, in which the optical signal can be distributed to the subscriber terminal 120.

Note that, the technical scope of the present invention is not limited to the above-described embodiments, and various modifications can be made without departing from the scope of the present invention.

For example, in the above embodiments, the optical networks NW1 and NW2 respectively include four terminals 1 and four terminals 2, but the number of terminals 1 and the number of terminals 2 may be any number as long as each of the number of terminals 1 and the number of terminals 2 is one or more. Each of the number of input optical fibers 20, distribution optical fibers 30, output optical fibers 40, connection optical fibers 60, and wavelength demultiplexers 50 may be any number as long as each of them is one or more.

In addition, the end portion of the connection optical cable C2 need not be equipped with a connector. In other words, the terminal 1 need not include the ports 12 and 14 with the receptacles 12a and 14a. In this case, the optical fibers 20 and 40 and the connection optical fibers 60 may be connected by fusion splicing. Similarly, the end portion of the supply optical cable C3 need not be equipped with a connector, and the receptacle 13a need not be provided in the distribution port 13.

In addition, the plurality of connection optical fibers 60 may be color-coded depending on the numbers (ordinal numbers) assigned to connection optical fibers 60. Similarly, the plurality of input optical fibers 20 may be color-coded. The plurality of output optical fibers 40 may be color-coded. In addition, among the connection optical fibers 60, the input optical fibers 20, and the output optical fibers 40, the optical fibers having the same assigned ordinal numbers may be colored the same color.

In addition, in the above embodiments, only one wavelength band B is set in the wavelength demultiplexer 50, but a plurality of wavelength bands may be set in the wavelength demultiplexer 50. In this case, the wavelength demultiplexer 50 may be connected to the same number of distribution optical fibers 30 (distribution ports 13 and subscriber terminals 120) as the number of set wavelength bands B.

In addition, it is possible to appropriately replace the constituent elements in the above-described embodiments with well-known constituent elements. Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1, 2: Terminal
2A: First terminal
2B: Second terminal
10: Housing
12: Input port
13: Distribution port
14: Output port
20: Input optical fiber
30: Distribution optical fiber
40: Output optical fiber
50: Wavelength demultiplexer
60: Connection optical fiber
120: Subscriber terminal (external terminal)

1. A terminal that inputs and outputs optical signals of optical fibers in an optical cable, the terminal comprising:
a housing;
an input port that introduces the optical signals into an inside of the housing;
wavelength demultiplexers that receive and demultiplex the introduced optical signals into a wavelength band and other wavelength bands other than the wavelength band;
a distribution port that distributes optical signals demultiplexed into the wavelength band to an external terminal; and
an output port that extracts optical signals demultiplexed into the wavelength bands to an outside of the housing, wherein
a total number of the wavelength demultiplexers is equal to a total number of the optical fibers, and
each of the wavelength demultiplexers is connected to a corresponding optical fiber of the optical fibers.

2. The terminal according to claim 1, wherein,
an input optical fiber transmits the introduced optical signals to one of the wavelength demultiplexers,
an output optical fiber transmits the demultiplexed optical signals from the one of the wavelength demultiplexers to the output port, and
a position in the input port is different from a position in the output port.

3. The terminal according to claim 1, wherein each of the wavelength demultiplexers has only one set wavelength band.

4. The terminal according to claim 1, wherein each of the wavelength demultiplexers has two or more set wavelength bands.

5. The terminal according to claim 1, wherein
one or more set wavelength bands of one of the wavelength demultiplexers are the same as one or more set wavelength bands of each of the other wavelength demultiplexers.

6. The terminal according to claim 1, wherein
one or more set wavelength bands of one of the wavelength demultiplexers are different from one or more set wavelength bands of each of the other wavelength demultiplexers.

7. An optical network comprising:
terminals each of which is the terminal according to claim 1.

8. An optical network comprising:
terminals each of which is the terminal according to claim 6, wherein the terminals include a first terminal and a second terminal,
each of the wavelength demultiplexers in the first terminal is connected to a corresponding one of the wavelength demultiplexers in the second terminal, and
in each of the wavelength demultiplexers in the first terminal, one of the wavelength demultiplexers in the first terminal has a set wavelength band different from a set wavelength band of the corresponding one of the wavelength demultiplexers in the second terminal.
